(19) United States
(12) Patent Application Publication
(10) Pub. No.: US 2007/0034317 A1
(43) Pub. Date: Feb. 15, 2007

(54) Method and apparatus for laminating glass sheets

(76) Inventors: Valdislav Sklyarevich, Bensalem, PA (US); Mykhaylo Shevelev, Feasterville, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/582,250

(22) Filed: Oct. 17, 2006

Related U.S. Application Data
(63) Continuation-in-part of application No. 11/453,409, filed on Jun. 15, 2006.
(63) Continuation-in-part of application No. 11/340,045, filed on Jan. 26, 2006.
Application No. 11/340,045 is a continuation-in-part of application No. 11/327,827, filed on Jan. 9, 2006.
Application No. 11/327,827 is a continuation-in-part of application No. 10/802,626, filed on Mar. 17, 2004, now Pat. No. 7,063,760.

(51) Int. Cl. B32B 37/00

(52) U.S. Cl. 156/106; 156/275.5; 156/285; 156/379.8; 156/380.9

(57) ABSTRACT

The invention relates to a method and apparatus for laminating glass articles without using an autoclave. The sandwich structure to be laminated is placed in a controllable vacuum and subjected to short wave radiation with specified frequency and power. Pressure that is applied continuously during the heating and cooling is also specified for achieving an appropriate bond. An apparatus appropriate for realizing the invented process is also provided. The apparatus includes a loading table, furnace, and cooling chamber that are adjusted to and adjoined to each to other. These parts provide the necessary conditions for high-quality laminating simple and multi-sandwich structures with high production rate and efficiency. The apparatus is inexpensive and fits into the space of two glass article lengths.

### CROSS REFERENCE

This application is a continuation-in-part of application Ser. No. 11/453,409, filed on 15 Jun. 2006, and application Ser. No. 11/340,045, filed on 26 Jan. 2006, which are continuations-in-part of application Ser. No. 11/327,827, filed on 09 Jan. 2006, which in turn is a continuation-in-part of application Ser. No. 10/802,626, filed on 17 Mar. 2004.

### BACKGROUND OF THE INVENTION

1. Field of the Invention

The present invention relates to a method and apparatus for laminating glass articles and other frangible materials, wherein a plastic film is sandwiched between the articles.

Flat or non-flat glass articles, ceramics, polymers, or combinations of these materials may be laminated in accordance with the teachings of the present invention.

2. Discussion of the Prior Art

Laminates provide a way of strengthening frangible material, for example glass, so as to extend its uses and to render it safer to use in certain circumstances. Thus laminated glass products can be used for automotive and aircraft glazing, glass doors, balustrades, bulletproofing and many other uses where the glass product must be strong and/or shatterproof.

In conventional laminated glass products a sheet of glass is bonded to a layer of polymer adhesive film, and a further sheet or layer of material is bonded to the other side of the adhesive film layer, so that the adhesive film is sandwiched between two outer layers. If the glass sheet is then struck a blow it cracks or breaks, but does not shatter into small hazardous sharp pieces as the broken pieces are still bonded to and held in place by the polymer layer. If the laminated glass is used in a car windscreen, therefore, occupants of the car are not showered with broken glass upon breakage of the windscreen.

A number of methods for producing such laminates have been disclosed. For Example, see U.S. Pat. Nos.: 5,268,049; 5,118,371; 4,724,023; 4,234,533; and 4,125,669. Laminated glass has been generally manufactured by a process wherein a stack of at least two sheets of glass having a plastic film called an intermediate film or laminating film, typically a plasticized polyvinyl butylal (PVB) film, sandwiched between each pair of adjacent sheets of glass which is subjected to evacuation, pressing and heating.

Usually this involves long heating under temperatures of around 80° C.-140° C. and high pressure, 4 MPa-20 MPa. The main problem encountered is that air is trapped between the film and glass surfaces, which air must be removed. This is required to prevent the laminate from bubbling. Removing the remainder of the air requires long heating and high pressure. The bubbling is a visible and objectionable defect that in most cases is absolutely unacceptable. Besides, bubbling within the laminate may reduce its strength in this area and cause de-lamination.

At the same time removing air is not an easy task because it is trapped between both sides of the plastic film and a glass sheet and there are only two mechanisms by which the air can escape: diffusion and dissolving in the film. Both processes are very slow, requiring long term heating and the application of high pressure. The bigger the glass sheet, the longer the time required. An especially long time is required for making multi-layer laminates. As a result, the productivity of such processes is low and they require considerable capital expenditure to set up the necessary costly apparatus, such as autoclaves. Many prior art patents focus on the solution of problems related to the air escaping. In U.S. Pat. No. 5,268,049, glass sheets are spaced apart, and in the method described by U.S. Pat. No. 5,268,049, a liquid resin is used. In U.S. Pat. No. 4,234,533 the two sheets are held at an angle and in U.S. Pat. No. 5,118,371 the thickness of PVB gradually increases (or decreases) from the one side to the other side of the glass sheets. In U.S. Pat. No. 3,509,015 a method is described for producing laminated glass by sealing the periphery of two parallel glass sheets with pressure sensitive tape and forcing resinous material under pressure into the inter-sheet space. The resinous material is forced through a self-closing valve held in place with the tape while trapped air escapes through an aperture in the taped seam at the top of the cell. U.S. Pat. No. 4,125,669 describes a similar method in which two glass panes are sealed all around except for a filling opening and an aeration opening, and a binder material is introduced into the envelope thus formed in an amount calculated to exactly fill the envelope. Putty is applied to the openings just before emergence of the binder upon laying the filled envelope flat.

U.S. Pat. No. 3,315,035 describes a method involving the maintaining of the glass sheets in opposite relationship, heating the sheets to about 200° F. and injecting a resin composition containing a hardening agent, preheated to about 200° F., into the inter-sheet space and curing the assembled article. In U.S. Pat. No. 4,234,533 the seal around the sheets is formed by a gas-permeable, resin-impermeable material such as “Scotchmount”. In some inventions (see for example U.S. Pat. Nos. 4,828,598 and 4,724,023) the laminating process is conducted in a vacuum. The vacuum environment helps air to escape and, in general, can reduce the level of trapped air. However, heating in a vacuum is always difficult, inefficient and therefore the laminating process still requires a long time. One more example is a method that was described in United States Patent Application Publication No. 2003/0148114. Total processing time was indicated as dozens of minutes. In addition, this method works with only special and expensive plastic material that has a moisture content below 0.35 percent.

A vacuum for de-airing is used in U.S. Pat. No. 6,340,045 as well. The heating and pressing processes are conducted in separate chambers that make the laminating quality unsatisfactory because of possible PVB shrinkage (nothing prevents this) and, what is more important, because nothing helps the PVB in flowing during heating. Rapid cooling and doing this without pressure makes the achievement of good laminates very questionable. In the patent “ . . . electrical (radiative) heating elements . . . or convective heating” were used for heating in the chamber that is under vacuum. Heating in a vacuum by “convective heating” is impossible and heating by electrical elements in a vacuum without specifying the temperature of this heater is very insufficient. The described apparatus is long (at least five lengths of the glass being processed: two locks, heating chamber, pressing chamber, cooling site) and quite complex.

Thus, all the above described methods of air bubble removal, are not fully effective and are complicated, are very sensitive to moisture inside and outside the film, the apparatuses are massive and ineffective and still, in most cases, require long term heating (high energy consumption) and special expensive equipment, such as high pressure autoclaves.

At the same time, extremely large numbers of windshields, windows and other laminate products are made each year. Accordingly, there is a clear need in the art for a more effective and less expensive method for laminating glass sheets which eliminates expensive and massive equipment and reduces energy consumption.

### SUMMARY OF THE INVENTION

According to the present invention, a method and apparatus are provided for laminating glass sheets and other frangible material with the thermal treatment of a laminating film that is processible by controlled heating which is fast and does not require the use of autoclave type furnaces. Products prepared using the method of the present invention include, but are not limited to, architectural glass, glass doors, balustrades, bulletproof glass, windshields, side windows and rear windows for vehicles such as automobiles and the like, as well as many other uses where the glass product must be strong and/or shatterproof, and comparable products. The inventive method utilizes short wave radiation such as microwave and/or infrared to rapidly apply heat in a vacuum to the adhesive film to be thermally treated.

The invented method comprises the assembly of a sandwich structure consisting of at least two glass articles separated by, and in contact with, at least one laminating film (usually this is plasticized polyvinyl butyral known as PVB) and placing the sandwich in a hermetic chamber and pumping it to the selected level in the range of approximately 1 kPa to approximately 20 kPa. Simultaneously with the pumping, at least one selected area of the sandwich structure is exposed to short wave radiation. The frequency of the radiation is selected in a way that provides exclusive heating of the film and optimal efficiency for the entire heating process. This is realized by selecting such frequency of the radiation which is approximately the sum of the thicknesses of the skin layer in the glass article facing the radiation source and the film. The power density of the radiation is selected to be sufficient to heat the film and adjoining glass surfaces to a predetermined film bonding temperature for selected adhesion with a heating rate of approximately 0.5° C./sec to approximately 5° C./sec. The determined heating rate provides the optimal conditions for pumping air and evaporation of water from the film and pumping this moisture seepage.

Simultaneously with pumping and heating, a pressure is applied to heat the area in a continuous manner during entire irradiation that is selected to be sufficient, depending on the selected bonding temperature (selected adhesion), vacuum pressure level and initial moisture content of the film. After reaching the selected temperature of the film the irradiation stops and cooling of the heated area is provided. The pressure equal to or higher than that used during heating is also continuously applied during cooling.

A multi-glass article structure can be also made by the method of the present invention. Fort his, the previously processed and cooled sandwich structure is assembled with one additional glass article that is separated by, and contacted with, the processed structure by, at least, one additional laminating film. The method of the present invention allows the repeat of this process many times.

An apparatus for realization of the method of the present invention is comprised of a loading table, furnace, and cooling chamber with conveyors for positioning the structure and moving it through the apparatus. The furnace is a hermetic chamber connected to a vacuum pump, and having shot wave radiation emitters that provide heating according the method of the present invention. The emitters are electrodynamic mirrors that transmit the microwave radiation or short wave infrared lamps or a combination of them. There are means inside the chamber for providing controllable distribution of short wave radiation over at least one selected area of the structure. The means includes, but is not limited to, a set of individually activated emitters of short wave radiation, movable electrodynamic mirrors, oscillating the sandwich under emitters, and/or using infrared reflectors with high reflection coatings.

The cooling chamber has not less than three intakes and each of them is configured with turns in the furnace exit. The intakes are moving by use of a vertical conveyor and each intake has a horizontal conveyor for accelerated conveyance of the processed structure from the chamber into and out of the intake.

Each chamber of the apparatus of the present invention has an arrangement for applying selected pressure during heating and cooling that is provided by rollers, pressurized air, or their combination. A set of flexible appliances, transparent to the short wave radiation, is used for pressing mainly non-flat articles during the heating and cooling. Cooling is provided by a stream of normal pressure air created by a fan or pressurized air from a compressor.

### BRIEF DESCRIPTION OF THE DRAWINGS

Other objects and advantages appear hereinafter in the following description and claims. The accompanying drawings show, for the purpose of exemplification, without limiting the invention or appended claims, certain practical embodiments of the present invention wherein:

FIG. 1 is a schematic drawing illustrating the laminating process in accordance with the teachings of the present invention;

FIGS. 2a, b, c, and d are schematic drawings and corresponding graphs illustrating temperature distributions inside the sandwich structure resulting from the irradiation by short wave radiation with different frequencies;

FIG. 3 is a schematic drawing illustrating the laminating process of the sandwich structure that consists of more than two glass articles in accordance with the teachings of the present invention;

FIG. 4 is a schematic layout of the apparatus of the present invention for laminating glass articles; and

FIGS. 5 schematically illustrates the position, and layout of the short wave emitters when pressing is provided by rollers.

### DETAILED DESCRIPTION OF THE PREFERRED EMBODIMENTS

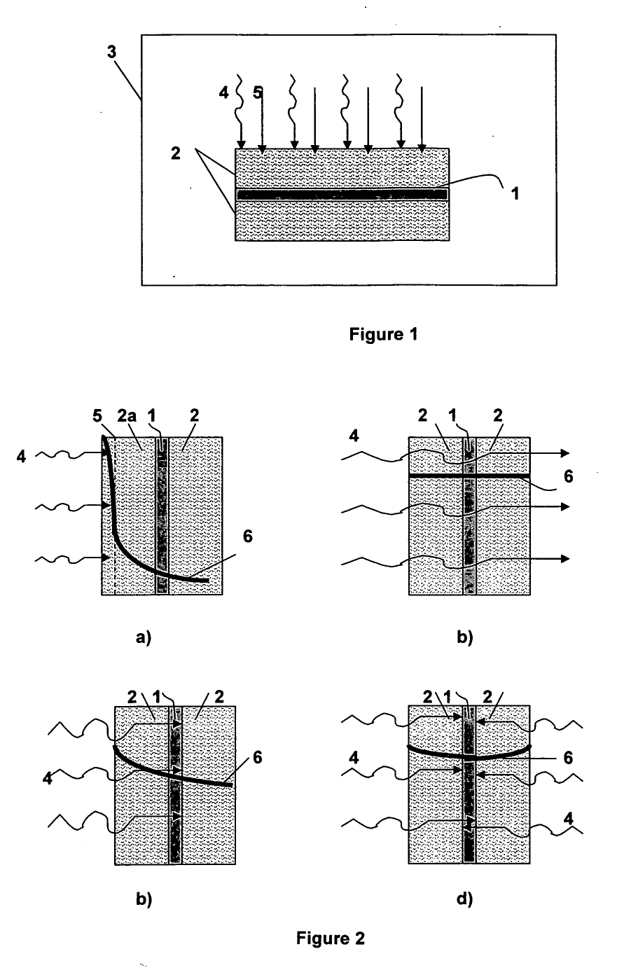

The present invention relates to a method of laminating frangible materials, preferably glass articles, without using autoclave type furnaces, to effect rapid and exclusive short wave radiation heating of the laminating film, preferably plasticized polyvinyl butyral (PVB). In the invention at least one laminating film (1) (see FIG. 1) is placed between two glass articles (2) and the resulting sandwich is placed in a hermetic chamber (3) where it is subjected to vacuum, short wave radiation (4) and pressure (5) simultaneously. The vacuum level, the radiation frequency, pressure, and heating rate are important variables in the inventive method.

### Short Wave Radiation Frequency

When short wave radiation meets with a sandwich, it penetrates inside it and heats the glass articles and film, losing energy:

I(x)=I(0)exp(−x/λ), where I(x) is the distribution of the radiation energy lost along the coordinate x—in the sandwich in the direction of radiation propagation; I(0) is the beginning level of the energy; and λ is the total sandwich absorption coefficient. The λ depends, first of all, on the radiation frequency and represents material electrodynamic properties (conductivity, molecular structure, etc.)

The distribution of the radiation energy lost I(x) (or heat distribution inside the material) for each particular material will depend on its thickness and radiation frequency. There can be three major cases here for a particular sandwich:

The first is when the frequency is high and correspondingly the absorption coefficient λ is high for the selected frequency. In this case, almost all energy will be coupled in the narrow layer (5) (see FIG 2a) of the glass article (2a) and the temperature difference (6) between layer (5) and film (1) will be significant. This would lead to problems with adhesion: it will be low, or different on different sides, etc. To avoid this, heating should be slow, and this would reduce production rate.

The second case is when the frequency is low and the absorption coefficient λ is correspondingly low for this frequency. In this case, the temperature difference (6) (see FIG. 2b) across the sandwich will be minor but the largest part of the radiation (4) will pass through. This would lead, first of all, to low efficiency of the heating process—a significant part of the energy will be lost. Besides, the heating will be slow (less energy would used) and this will also reduce the production rate. Increasing this rate will require increasing power, that increases the equipment costs and such power generators might be not available.

Finally, if frequency is so selected so that the coefficient k becomes equal to the distance x (that is the selected thickness of the sandwich that is needed to be heated) most of the energy (63%) is used and the temperature difference between the layers inside the material will be insignificant. Such thickness of penetration is known as the skin layer.

In all of the embodiments of the present invention, a frequency of the short wave radiation, for the skin layer in the glass article facing the radiation source and the film, which is around the sum of their thicknesses, is proposed. In this case, a high production rate and energy efficiency are granted. The thermal gradient (6) (see FIG. 2c) will be insignificant so that equal conditions are provided for the absorption from both sides of the film. In addition, the sandwich can be irradiated from both sides, making said gradient (6) (see FIG. 2d) even more linear. Radiation with this frequency can be selected from a high frequency microwave or infrared band range.

### Vacuum Level, Pressure, Heating Rate

When the assembled sandwich is placed in a vacuum, pressured, and irradiated by short wave radiation, the following processes take place. In the beginning while the sandwich is comparatively cold, the air and moisture that was captured in between the film and glass articles are pumped out and the pressure of the remaining gases becomes equal to the surrounding pressure in the chamber. As the temperature is raised, the water that is always present inside the film is evaporated from the film and creates steam in between the film and glass articles. This steam is also pumped out and the partial pressure between the film and glass is equal to the surrounding pressure in the chamber as well. The described process takes place up to the moment when the further-heated film sticks to the glass, closing the paths for further pumping of the evaporated water steam. As the film temperature is raised, the applied pressure provides dissolving of the remaining gases (air and steam) back into the film. The applied pressure also assists the film material flowing, promoting the adhesion process and preventing returning of the gases into the film and thereby creating bubbles.

The selected short wave radiation, along with sufficient power/power density, can provide a very high heating rate (production rate) because it does not create any significant stresses in the glass articles, it provides equal conditions for adhesion from the film on both sides, and a highly efficient heating process. However, a heating rate which is too high reduces pumping time and increases the quantity of remaining water inside the film. It was found that heating faster than around 5° C. per second is not appropriate because it requires high pressing pressure with very high uniformity. In fact, heating that is too fast requires the use of an autoclave. It also creates a problem for the heating process because it requires very high uniformity. Slower heating makes heating and pressing easy but reduces the production rate. In the present invention, the lower limit of the heating rate is around 0.5° C. per second, providing a reasonable, generally acceptable minimal production rate.

It was found that for the heating rate range, the pressure that needs to be applied during the structure heating (in Pa) should not be less than: 14 (coefficient)×{vacuum pressure in the chamber}^{1/2}(in Pa)×exp {0.3×(150° C. minus selected bonding temperature)} (in °C.)×{a moisture content of the film material} (in percent by weight). In the present invention, the vacuum level is determined to be between approximately 1 kPa to approximately 30 kPa. Achieving a vacuum level lower than 1 kPa requires expensive evacuation systems and it is not reasonable because it has insignificant advantages for the pressing and heating process, as well as for the final laminate quality. It is found that subjecting the structure to a vacuum higher than 30 kPa is also not appropriate because the required pressure is raised dramatically and makes the pressing process very complicated and expensive.

In the invented method, the production rate is increased by disconnecting the chamber from evacuation pumping and opening it to environmental or pressurized air when the film temperature reaches approximately 70-75% of the determined bonding temperature. This saves time, for opening the chamber for further processing actions.

In the invented method, the cooling of the heated sandwich structure is provided continuously at the same pressure as is applied during heating, or higher. It is necessary to prevent the remaining water inside the film from coming out and creating bubbles while the film is still hot and soft as well as promote the creation of an appropriate bond between glass surfaces and the film. Performing cooling in a separate chamber increases the production rate.

In the embodiments of the invention discussed above, the cooling chamber is a hermetic chamber and cooling is accomplished at normal or increased environmental pressure. In the invented method pressurized air is used as the increased environmental pressure.

In the embodiments of the invention discussed above, the pressure during the heating and cooling is accomplished by rollers, a set of flexible appliances transparent to the short wave radiation, pressurized air or their combination.

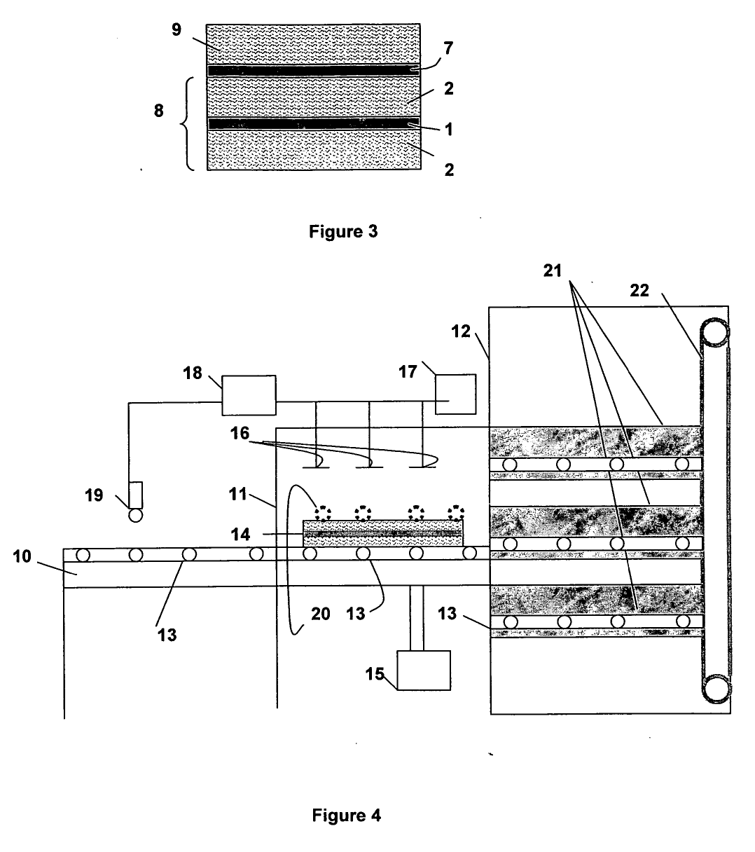

A sandwich structure that consists of more than two glass articles can be laminated by the invented method. For this, at least one additional laminating film (7) (see FIG. 3) is placed between a sandwich structure previously processed by the invented method (8) and additional glass articles (9) and the resulting multi-sandwich structure is processed according to invented method as is described above. For a laminate structure with 4, 5, or more glass articles, the described process is repeated a corresponding number of times.

The apparatus is invented for laminating, by the described method, a sandwich structure, consisting of at least two glass articles separated by, and in contact with, at least one laminating film. It includes a loading table (10) (see FIG. 4), furnace (11) and cooling chamber (12). Each part has a conveyor (13) for positioning the structure (14) and to provide movement. All parts are adjusted and adjoined to one other. A common assembly table can be used as a loading table.

The furnace (11) is a hermetic chamber. It is connected to a vacuum pump (15) that creates the selected vacuum inside the chamber as specified in the method, in the range of approximately 1 kPa to approximately 20 kPa. The chamber (11) has short wave radiation emitters (16) inside that provide heating of at least one selected area of the film and adjoining glass article surfaces. The emitters are connected to a control block (17) that controls the power of the short wave radiation to provide heating of the film and surfaces to a predetermined film bonding temperature for selected adhesion with a heating rate of approximately 0.5° C./sec to approximately 5° C./sec. This control also synchronizes and controls the operation of all parts of the apparatus including conveyor motion and oscillating the sandwich inside the chamber during heating. The emitters are electrodynamic mirrors when the short wave radiation is high frequency microwave, or infrared lamps if infrared is used as a short wave radiation, or a combination of them. The controllable distribution of short wave radiation is provided by means that include, but are not limited to, a set of individually activated emitters of short wave radiation, infrared reflectors with high reflection coatings, scanning and/or movable electrodynamic mirrors, a computer (18) with a pre-programmable control for the means, an optical system (19) at a loading table for scanning the position of the sandwich structure or a group of them thereon, and a computer, programmable by the system for controlling the means.

The furnace has an arrangement for applying the pressure that is specified in the invented method continuously during heating. This arrangement includes, but is not limited to rollers (20), a set of flexible appliances transparent to the short wave radiation, or a combination of them. At the end of the heating cycle, as specified in the invented method, the arrangement includes pressurized air.

The cooling chamber (12) has not less than three intakes (21) that are moved by horizontal conveyor (22) in a vertical direction. Each intake has a horizontal conveyer for accelerated conveying of the processed structure from the chamber into and out of the intake. Each intake has an arrangement similar to what is described above, that presses the sandwich with pressure equal to or higher than that which is selected for the heating cycle.

The cooling system for reducing the sandwich temperature to the selected safe level includes, but is not limited to, a set of fans, pressurized air, or a combination of them. In the case of using pressurized air, the cooling chamber is a hermetic chamber.

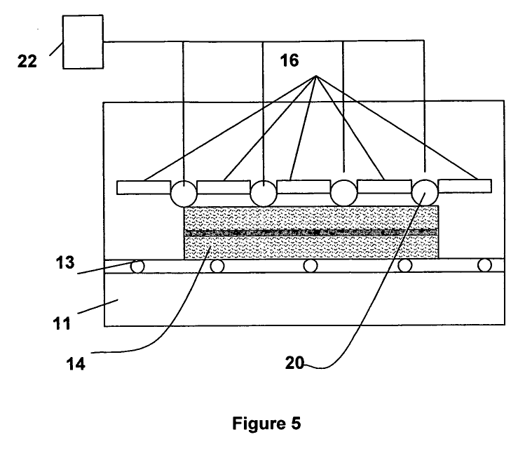

In the case of using rollers (20) (see FIG. 5) in the furnace (11) for creating the pressure, the emitters (16) are fixed between the rollers (20) and the sandwich structure (14) is oscillated by the chamber conveyor (13) during heating with an amplitude of at least more than the diameter of the rollers. The rollers have a lifted unit (22) that raises them before heating to provide space between them and the chamber conveyor that is bigger than the sandwich structure thickness. The rollers are located with a distance between them that provides the pressing of the sandwich by, at least, two rollers simultaneously at any time during the heating.

The furnace and cooling chamber have hermetic gates that allow movement of the sandwich structure through the apparatus. For this purpose, in one of the embodiments of the invention discussed above, the furnace has a retractable roof.

The invented method and apparatus provide for laminating glass articles without using an autoclave and are free from all autoclave problems. The apparatus is inexpensive, take less space and energy, provides the opportunity to laminate any kind of glass article, including tempered and coated glass etc., as well as, multi-structures having many glass articles. The method and apparatus can be the basis for high production laminating lines. Only common simple parts such as washing, drying, unloading, etc. need to be added. The invented method and apparatus can be used for retrofitting into existing lines as well, liberating production from the problems of autoclave use and batch processing. The apparatus of the present invention can also be installed in parallel with an existing autoclave line for making laminates while the autoclave is running. This will double, or even triple production.

The invented method and apparatus ensure a high quality laminate that has been proven by testing laminate samples that were made using the invention.

Samples of flat soda-lime glass articles 12″ by 12″ (300×300 mm) and 16″×30″ (406×760 mm), 3/16″ (4.76 mm) thick with one layer of PVB 0.03″ (0.7 mm) thick in each sample were made by the invented method and apparatus. The assembled sandwiches were placed in the vacuum chamber with a vacuum of 150 mm Hg (20,000 Pa) and irradiated by infrared lamps with a wavelength of 1.26 microns for which the measured skin layer was around 5 mm. Behind the lamps, polished brass reflectors were installed. The total power of the infrared lamps used was 6 kW for samples 300×300 mm, and 22 kW for samples 406×760 mm. The selected bonding temperatures were between 137° C. and 145° C. The mentioned power level used provided a heating time of around 50 sec with a heating rate of around 2.4 C/sec. The PVB moisture content was between 0.5% and 1.1%. For this data, applied pressures were estimated to be between P=14×20,000^{1/2} (Pa)×exp {0.3×(150−137)}×1.1 (%)=14×141×exp(3.9)×1.1=1610×49.4=79.5 kPa=0.8 kg/cm² and P=14×20,000^{1/2} (Pa)×exp {0.3×(150−147)}×0.5(%)=805×2.5=2,000 Pa or 0.02 kg/ cm². The samples were pressed by rollers.

The samples successfully passed official safety glass tests: impact, boiling, and pummel. Results of the tests are attached as Appendix I. Samples of flat soda-lime glass articles 12″ by 12″ (300×300 mm), 3/16″ (4.76 mm) thick with one layer of PVB in each, that had different moisture contents, were processed by the invented method using the invented apparatus and tested by DuPont's testing lab. (DuPont is one of the major PVB manufacturers).

Below are results of sample baking tests.

Ts&d 06-0211 Gyrotron

| | | INTO OVEN | | | | | | | | |
|---|---|---|---|---|---|---|---|---|---|---|
| | | 6:30 | 8:30 | | 10:30 | | 12:30 | | 2:30 | |
| | | | TEMP deg C./deg F. | | | | | | | |
| | | | 105/221 | | 120/248 | | 135/275 | | 150/302 | |
| | | | BUBBLE COUNT AT TEMPERATURE INSIDE AND OUTSIDE OF ½ INCH) | | | | | | | |
| SAMPLE CODE | | INITIAL COUNT | INSIDE | OUTSIDE | INSIDE | OUTSIDE | INSIDE | OUTSIDE | INSIDE | OUTSIDE |
| 1 | PVB 1 | 0 | | 0 | | 0 | | 0 | | 0 |
| 2 | PVB 2 | 0 | | 0 | | 0 | | 0 | | 0 |
| 3 | PVB 3 | 0 | | 0 | | 0 | | 0 | | 0 |
| 4 | PVB 4 | 0 | | 0 | | 0 | | 0 | | 0 |
| 5 | SGP 1C | 0 | | 0 | | 0 | | 0 | | 0 |
| 6 | SGP 2C | 0 | | 0 | | 0 | | 0 | | 0 |

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

We claim:

1. A method for laminating glass articles, comprising:
assembling a sandwich structure consisting of at least two glass articles separated by at least one laminating film;
placing said sandwich structure in a hermetic chamber;
subjecting said sandwich structure to a vacuum of approximately 1 kPa to approximately 20 kPa;
irradiating at least one selected area of said sandwich structure by short wave radiation with a frequency for which the skin layer in the glass article facing the radiation source and the film is around the sum of their thicknesses, and having a power density sufficient to heat the film and adjoining glass surfaces to a predetermined film bonding temperature for selected adhesion with a heating rate of approximately 0.5° C./sec to approximately 5° C./sec;
applying pressure in a continuous manner during irradiation that is selected to be P(in Pa)≧14×{remaining partial pressure of air and moisture seepage from the film at the end of the heating}^{1/2}(in Pa)×exp {0.3×(150° C. minus selected bonding temperature)} (in °C.)×{a moisture content of the film material} (in percent by weight); and
cooling said heated area under the selected pressure or higher pressure whereby an appropriate bond is obtained between said laminating film and said glass articles in at least said selected area.

2. The method of claim 1, wherein said short wave radiation with said frequency is selected from a high frequency microwave radiation band range.

3. The method of claim 1, wherein said short wave radiation with said frequency is selected from the infrared band range.

4. The method of claim 1, wherein heating of said film to a temperature higher than approximately 70-75% of the determined bonding temperature is conducted in normal or increased environmental pressure.

5. The method of claim 1, wherein cooling is conducted in normal or increased environmental pressure.

6. The method according to claim 1, wherein said pressure is created by rollers.

7. The method according to claim 1, wherein said pressure is created by a set of flexible appliances transparent to the said short wave radiation.

8. The method of claim 1, wherein cooling is performed in a separate chamber.

9. The method of claim 8, wherein the separate chamber is a hermetic chamber.

10. The method according to claim 1, wherein the sandwich structure consists of a previously processed and cooled sandwich structure and one additional glass article that is separated from the processed structure by at least one additional laminating film.

11. The method of claim 4, wherein said pressure is created by pressurized air.

12. An apparatus for laminating a sandwich structure consisting of at least two glass articles separated by at least one laminating film comprising:
a furnace having an entrance and an exit;
a loading table with a conveyor for positioning the structure on the table and for movement from the table into the furnace through the entrance for the furnace;
said furnace having a hermetic chamber connected to a vacuum pump and having a conveyor for conveying said structure from the table to inside the chamber and conveying said structure out of the furnace, short wave radiation emitters that provide heating of at least one selected area of the film and adjoining glass article surfaces to a predetermined film bonding temperature for selected adhesion with a heating rate of approximately 0.5° C./sec to approximately 5° C./sec, means for providing controllable distribution of short wave radiation over at least one selected area of the structure, means for applying a selected pressure in Pa that is equal to or more than the product of 14×{remaining partial pressure of air and moisture seepage from the film at the end of the heating}^{1/2}(in Pa)×exp {0.3×(150° C. minus selected bonding temperature)} (in °C.)×{a moisture content of the film material} (in percent by weight) to the heated structure area continuously during the heating;
a second chamber for cooling said sandwich as processed that is adjacent to the furnace and having not less than three intakes whereby each intake is presented in turn to the furnace exit by a vertical conveyor, and each of said intakes having a horizontal conveyor for conveying the processed structure from the chamber into and out of the intake, and means for applying pressure equal to or higher than the selected pressure applied during heating, and a cooling system for reducing the temperature of said sandwich temperature to a selected safe level.

13. The apparatus defined in claim 12, wherein said short wave radiation emitters include electrodynamic metal mirrors that transmit and shape the microwave radiation.

14. The apparatus defined in claim 12, wherein said short wave radiation emitters include short wave infrared lamps.

15. The apparatus defined in claim 12, wherein said short wave radiation emitters include a combination of electrodynamic mirrors and infrared lamps.

16. The apparatus defined in claim 12, wherein said means for providing controllable distribution of short wave radiation includes a set of individually activated emitters of short wave radiation.

17. The apparatus defined in claim 12, wherein said means for providing controllable distribution of short wave radiation includes movable electrodynamic mirrors.

18. The apparatus defined in claim 12, wherein said means for providing controllable distribution of short wave radiation includes infrared reflectors with high reflection coatings.

19. The apparatus defined in claim 12, wherein said means for providing controllable distribution of short wave radiation includes a computer with a pre-programmable control for said means.

20. The apparatus defined in claim 12, wherein said means for providing controllable distribution of short wave radiation further includes an optical system at the loading table for scanning the position of said sandwich structure, or a group of them, thereon and a computer programmable by said system for controlling said conveyors and said means for providing controllable distribution of short wave radiation.

21. The apparatus defined in claim 12, wherein said means for applying the selected pressure includes rollers.

22. The apparatus defined in claim 21, wherein said emitters are fixed between rollers and the sandwich structure is oscillated by the chamber conveyor during heating with an amplitude of at least more than the diameter of the rollers.

23. The apparatus defined in claim 21, wherein the rollers are raised before heating to provide space between them and the chamber conveyor and this space is wider than the sandwich structure thickness.

24. The apparatus defined in claim 21, wherein the rollers are located at a distance between each other that provides the pressing of the said sandwich by at least by two rollers simultaneously at any time during the heating.

25. The apparatus defined in claim 12, wherein said means for applying the selected pressure includes pressurized air.

26. The apparatus defined in claim 12, wherein said means for applying the selected pressure includes a set of flexible appliances transparent to the said short wave radiation.

27. The apparatus defined in claim 12, wherein said means for applying the selected pressure includes a combination of rollers, a set of flexible appliances transparent to the said short wave radiation, and pressurized air.

28. The apparatus defined in claim 12, wherein the second chamber is a hermetic chamber.

29. The apparatus defined in claim 12, wherein the hermetic chamber has a retractable roof.

30. The apparatus defined in claim 12, wherein both chambers have hermetic gates.

31. The apparatus defined in claim 12, wherein the cooling system includes a set of the fans.

32. The apparatus defined in claim 12, wherein the cooling system includes a flow of pressurized air.

33. The apparatus defined in claim 12, wherein the loading table is a common assembling table.

34. The apparatus defined in claim 12, wherein said furnace has a retractable roof.

35. The apparatus of claim 12, wherein said furnace and said cooling chamber each has hermetic gates.
